(19) United States
(12) Patent Application Publication
(10) Pub. No.: US 2012/0329947 A1
(43) Pub. Date: Dec. 27, 2012

(54) INTEGRATION OF PRECOATED NANOSTRUCTURES INTO BULK COMPOSITE MATRICES

(75) Inventor: Kirk Jeremy Ziegler, Gainesville, FL (US)

(73) Assignee: UNIVERSITY OF FLORIDA RESEARCH FOUNDATION, INC., Gainesville, FL (US)

(21) Appl. No.: 13/527,952

(22) Filed: Jun. 20, 2012

Related U.S. Application Data
(60) Provisional application No. 61/499,802, filed on Jun. 22, 2011.

(51) Int. Cl. C08K 7/00; B29D 7/00; C08L 77/00; B82Y 40/00

(52) U.S. Cl. 524/847; 425/224; 977/750; 977/752; 977/845

(57) ABSTRACT

Various methods and systems are provided for preparing a polymer nanocomposite. In one embodiment, among others, a method includes providing a first immiscible solution including an aqueous solution including polymer-coated nanoparticles and a first monomer and a second immiscible solution including an organic solution including a second monomer. The first and second immiscible solutions are in contact along an interface. A polymer nanocomposite, including the polymer-coated nanoparticles dispersed within the polymer matrix, is extracted from the interface. In another embodiment, a system includes a vessel and an extraction assembly. The vessel includes a first immiscible solution layer in contact with a second immiscible solution layer along an interface. The first immiscible solution layer includes an aqueous solution including polymer-coated nanoparticles and a first monomer. The second immiscible solution layer includes an organic solution including a second monomer. The extraction assembly is configured to extract the polymer nanocomposite from the interface.

### CROSS REFERENCE TO RELATED APPLICATIONS

This application claims priority to copending U.S. provisional application entitled “INTEGRATION OF PRECOATED NANOSTRUCTURES INTO BULK COMPOSITE MATRICES” having Ser. No. 61/499,802, filed Jun. 22, 2011, the entirety of which is hereby incorporated by reference.

### BACKGROUND

Single-walled carbon nanotubes (SWNTs) have received considerable attention due to their unparalleled combination of electrical, optical, and mechanical properties, as well as their chemical inertness. Various applications have been demonstrated based on these extraordinary properties, ranging from nanocomposite materials, sensors, biomedical application, and electronic devices to energy storage and generation. However, integrating individual SWNTs into applications is problematic.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is the reaction that takes place in accordance with various embodiments of the present disclosure.

FIG. 2 is a graphical representation of a microenvironment around a single walled carbon nanotube (SWNT) in accordance with various embodiments of the present disclosure.

FIG. 3 is a plot illustrating examples of the fluorescence spectra of mixtures including the SWNT of FIG. 2 in accordance with various embodiments of the present disclosure.

FIG. 4 is a graphical representation illustrating the coating of the SWNT of FIG. 2 through interfacial polymerization in accordance with various embodiments of the present disclosure.

FIG. 5 is a plot illustrating examples of the fluorescence spectra of the SWNT of FIG. 5 before and after polymerization in accordance with various embodiments of the present disclosure.

FIG. 6 is a picture illustrating freeze-dried SWNTs and redispersion of the SWNTs in accordance with various embodiments of the present disclosure.

FIG. 7 is a picture illustrating an in-situ interfacial polymerization reaction forming a polymer matrix along the interface between two immiscible solutions in accordance with various embodiments of the present disclosure.

FIGS. 8A-8B, 9, and 10 illustrate the formation of fibers from the interfacial polymerization of FIG. 7 in accordance with various embodiments of the present disclosure.

FIG. 11 is a picture of composite fibers spun from the interfacial polymerization of FIG. 7 in accordance with various embodiments of the present disclosure.

FIG. 12 is scanning electron microscope (SEM) images illustrating the dispersion of the SWNTs in the composite fiber of FIG. 11 in accordance with various embodiments of the present disclosure.

FIG. 13 is a plot illustrating the RBM region of the Raman spectra at various positions along the composite fiber of FIG. 11 in accordance with various embodiments of the present disclosure.

FIG. 14 is a plot illustrating the Raman spectra difference between uncoated and precoated composite fibers in accordance with various embodiments of the present disclosure.

FIG. 15 is a plot illustrating the NIR fluorescence emission spectra from the SWNTs distributed along the composite fiber of FIG. 11 in accordance with various embodiments of the present disclosure.

FIGS. 16 and 17 are plots illustrating differential scanning calorimetry (DSC) data for heating and cooling scans of nylon-6,10 and composite samples in accordance with various embodiments of the present disclosure.

FIG. 18 is a plot illustrating thermogravimetric analysis (TGA) data of nylon-6,10 and composite samples in accordance with various embodiments of the present disclosure.

FIG. 19 is a plot illustrating stress-strain curves of nylon-6,10 and composite samples in accordance with various embodiments of the present disclosure.

### DETAILED DESCRIPTION

Disclosed herein are various embodiments of methods and systems related to carbon nanostructures integrated into bulk composite matrices. Reference will now be made in detail to the description of the embodiments as illustrated in the drawings, wherein like reference numbers indicate like parts throughout the several views.

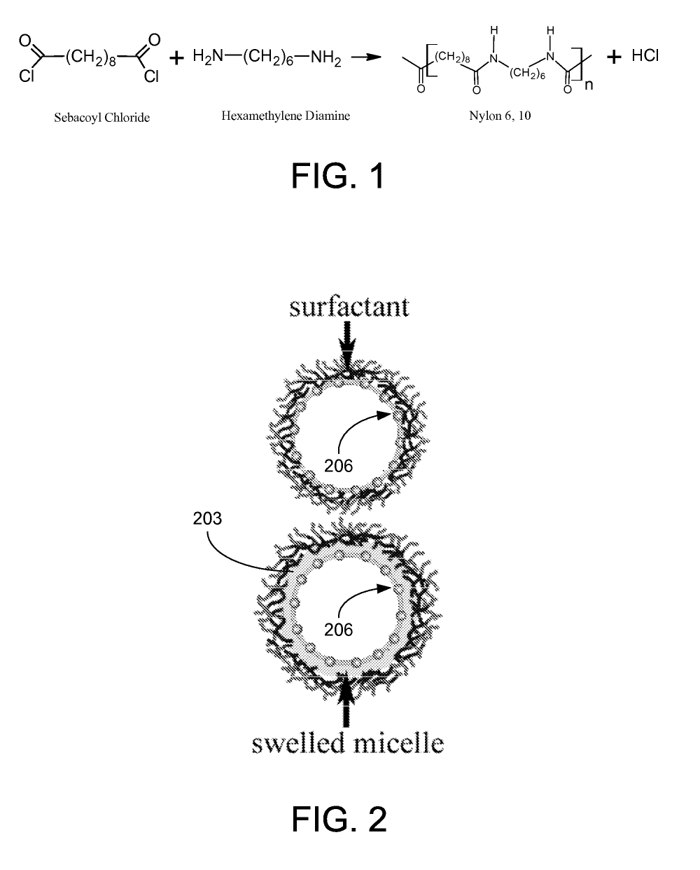

In-situ polymerization may be utilized to produce polymers along an interface between two immiscible solutions, each including a monomer, e.g., an aqueous solution including hexamethylene diamine (HMDA) and an organic solution including sebacoyl chloride (SC) may be used to produce nylon-6,10. FIG. 1 shows the condensation reaction of nylon-6,10, which involves SC and HMDA. In-situ polymerization is also effective for polymer nanocomposite fabrication where nanoparticles are integrated and dispersed within the composite matrices. The fabrication involves dispersing nanoparticles (e.g., nanotubes) in the aqueous solution followed by polymerization to form bulk composite matrices including the nanoparticles. One advantage is the capability to obtain molecular-scale reinforcement due to the small size of monomeric molecules. Improved dispersion of nanotubes in the composite can aid performance. Combined with the preliminary production of polymer-grafted nanotubes that can have better affinity with polymer chains, the distribution uniformity within the final composite can be higher than directly mixing nanotubes and polymers in solution. In-situ polymerization allows covalent bonds to be formed between functionalized nanotubes and the polymer matrix.

Carbon nanotubes (CNTs) or other carbon nanostructures or nanoparticles (e.g., graphene) may be utilized as a nanofiller for reinforcing the properties of polymer nanocomposites. The excellent electrical conductivity and high surface area of CNTs make them well suited for nanoscale electrodes for devices and sensors. Other applications can include, e.g., field emission electron sources for flat panel displays, where they have advantages over liquid crystal displays, such as low power consumption, higher brightness, faster response speed, wider visible angle, and larger operating temperature range. CNTs can be categorized as single-walled carbon nanotubes (SWNTs) or multi-walled carbon nanotubes (MWNTs). However, CNTs have a tendency to agglomerate in bundles due to a strong van der Waals force of attraction, which cause dispersion issues that can diminish the performance of the composite.

Using CNTs can improve the mechanical properties as well as the electrical and thermal properties of the nanocomposite structure. Typically, the properties of CNT/polymer nanocomposites vary with several factors such as, e.g., the synthetic processing and purification of nanotubes, impurities in the nanotubes, differences in the distribution of nanotubes (e.g., different (n, m) types, lengths, and/or diameters), the aggregation state in the polymer matrix (i.e., individual or bundled), and the orientation of nanotubes in the matrix. The mechanical properties of the polymer matrices such as, e.g., tensile modulus may also be improved. Accordingly, fabricating a nanocomposite with CNTs may include the preliminary steps of: (a) eliminating impurities in CNTs; (b) removing bundles to maximize the amount of individual CNTs; (c) chemically modifying the surface of CNTs to maximize dispersion.

Modifying the surface of CNTs (e.g., SWNTs) to establish a stronger chemical affinity allows the CNTs to disperse individually and uniformly throughout the polymer, preferably achieving a high dispersion of the CNTs through non-covalent bonds so that their integrity is not destroyed and the nanotubes can be used more effectively in composites. For example, the dispersion of SWNTs may be enhanced by controlling the interfacial properties of SWNTs. In order to effectively incorporate SWNTs into a polymer matrix, a chemical procedure is utilized to modify the nanotubes so that they have higher affinity with the polymer matrix. For example, SWNTs may be precoated with the polymer to increase dispersion of the individual nanostructures within the polymer composition matrices.

Covalent modification requires a strong chemical bond or graft between the polymer and CNTs. Depending on the way the polymer chains are formed, covalent modification can be further divided into “grafting to” and “grafting from” nanotube methodologies, although both approaches require covalent bonding to the nanotube. The “grafting to” approach is when polymers of a specific molecular weight are reacted onto the sidewall of the nanotube and the polymer is terminated with a radical precursor or reactive group. In the “grafting from” approach, polymers are grown around the surface of the nanotube by using in-situ polymerization, which has also been called surface-initiated polymerization. After the functionalization step, the nanotubes are integrated into the matrix by initiating another polymer reaction.

A non-covalent bonding modification can increase the dispersion and binding with the matrix so that the inherent electrical, optical and even mechanical properties of the SWNTs can be maintained. Non-covalent surface modification of SWNTs involves the physical adsorption or direct coating of a polymer to the surface of nanotubes. In some cases, surfactants may assist the dispersion of SWNTs prior to the adsorption of polymer. Surfactants can disperse either organic or inorganic particles by non-covalent physical adsorption onto the surface. Anionic surfactants such as, but not limited to, sodium dodecyl sulfate (SDS) and sodium dodecylbenzene sulfonate (SDBS) can be used to get SWNTs suspensions with high dispersion quality. Nonionic surfactants such as natural (e.g., Gum Arabic) and artificial polymers may also be used.

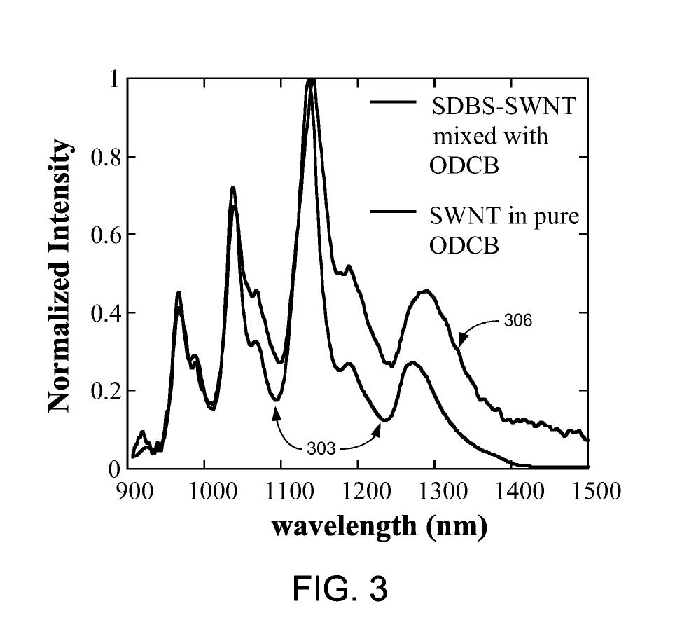

Although some polymers can be wrapped around nanostructures, in general, encasing CNTs with polymers in an aqueous phase has been challenging. In addition, there is little to no driving force for monomers or polymers to exist on the surface in organic solvents. However, these compounds can be dissolved in organic solvents and subsequently introduced onto the surface of the CNT using solvent microenvironments that form around the nanostructures. FIG. 2 is a cross-sectional view showing that organic solvents can swell the hydrophobic core 203 of surfactant micelle surrounding a SWNT 206, especially SDBS, to yield an emulsion-like microenvironment surrounding the SWNTs 206. Significant solvatochromic redshifts of the spectra occur after mixing the initial suspension with o-dichlorobenzene (ODCB). Referring to FIG. 3, shown are fluorescence spectra of SWNT mixtures. Comparing the fluorescence spectra 303 from SWNTs with SDBS surfactant mixed with ODCB to the fluorescence spectra 306 from SWNTs suspended in only ODCB (i.e., no water or surfactant) shows similar peaks, especially for the smallest diameter SWNTs (associated with shorter wavelengths). These results show that the hydrophobic core 203 of the surfactant has swelled with ODCB forming a solvent microenvironment around the CNT 206 (FIG. 2).

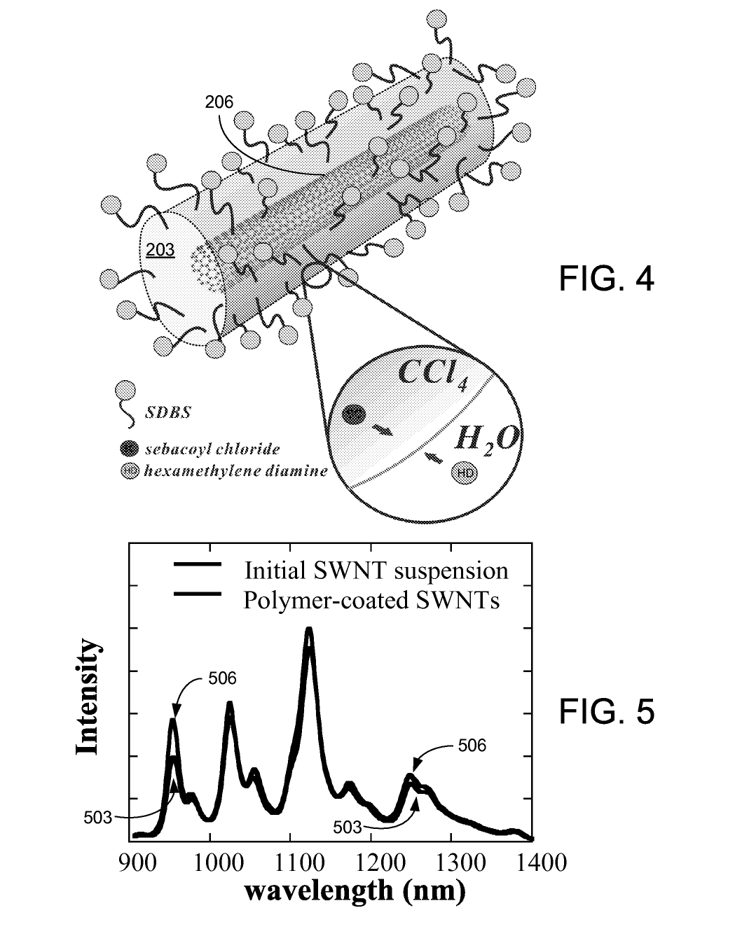

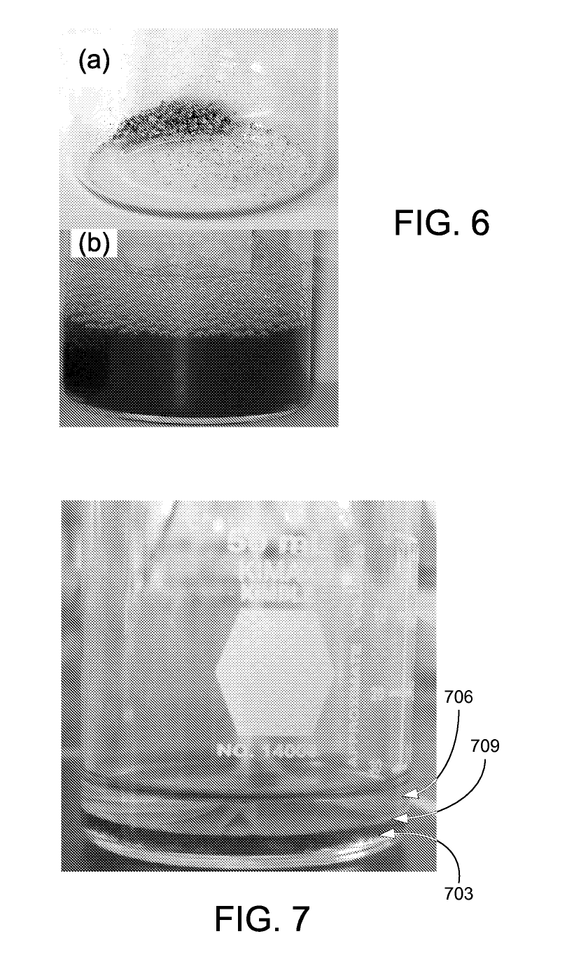

These swelled micelle states surrounding CNTs can be used for in situ interfacial polymerization. Referring to FIG. 4, shown is a graphical representation illustrating the coating of SWNTs 206 through interfacial polymerization. The controlled polymerization of a sheath surrounding SWNTs 206 is generated by dissolving one or more monomers in the oil phase surrounding the SWNTs. After formation of the emulsion phase encasing the SWNTs 206, other monomers or initiators can be introduced into the aqueous phase. The polymerization only occurs at the interface of the hydrophobic core 203 surrounding the SWNT 206 (e.g., see FIG. 4 for an example of the polymerization of nylon 6,10). These polymerized CNTs remain dispersed in the aqueous phase. Further, no covalent functionalization of the sidewalls has occurred indicating that the intrinsic properties of the SWNTs 206 are maintained. For example, as illustrated in FIG. 5, these coated CNTs maintain about the same fluorescence intensity after polymerization (curve 503) as before polymerization (curve 506) even in an acidic environment. The SWNTs can also be freeze-dried and redispersed. FIG. 6(a) is a picture of freeze-dried SWNTs and FIG. 6(b) is a picture of the redispersed SWNTs.

The precoated nanostructures may be integrated into bulk composite matrices by, e.g., spinning into fibers. For example, fibers of nylon-6,10 may be spun including precoated CNTs. Referring to the picture of FIG. 7, the in-situ interfacial polymerization reaction to form nylon 6,10 involves two immiscible solutions: an aqueous solution 703 including HMDA and an organic solution 706 including sebacoyl chloride (SC). SWNTs that are precoated with nylon-6,10 are included in the aqueous solution 703. As can be seen in the picture of FIG. 7, a thin film of the polymer composite forms along the interface 709 between the two immiscible solutions 703 and 706. In the embodiment of FIG. 7, the bottom layer is the aqueous solution 703 including HMDA and precoated SWNTs and the top layer is the organic solution 706 including SC dissolved in hexane. In other embodiments, the position of the aqueous solution 703 and the organic solution 706 may be reversed.

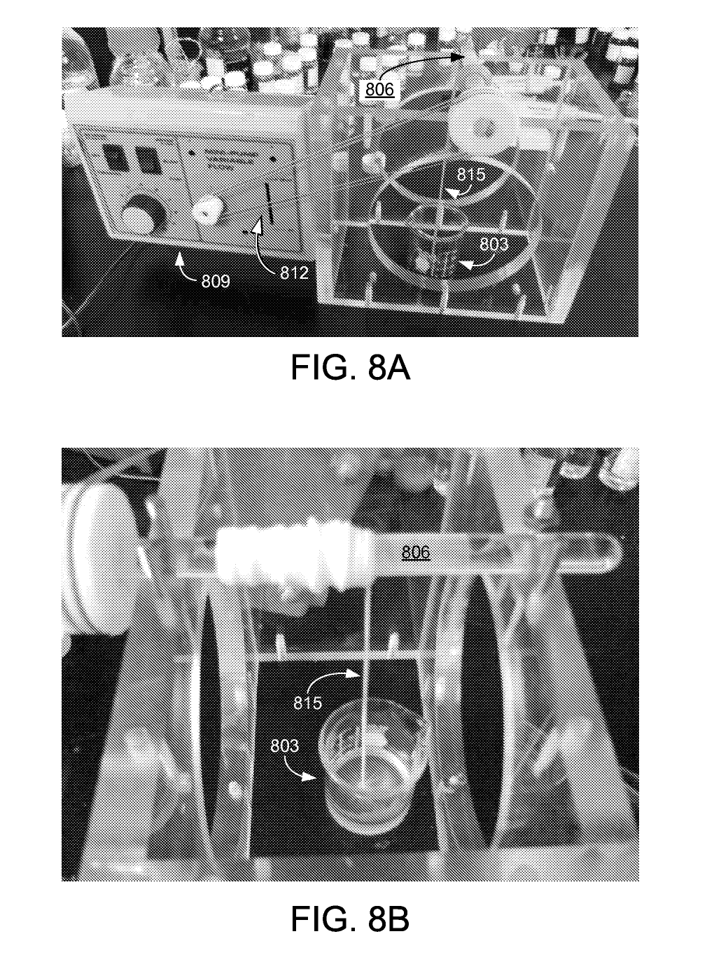

The composite formed at the interface 709 can be spun into fibers including the precoated SWNTs using a setup of a system such as that depicted in FIGS. 8A and 8B. The non-covalently precoated SWNTs are integrated into a bulk nylon-6,10 composite during the polymerization. The system arrangement of FIGS. 8A and 8B enables continuous fibers to be spun from the composite formed along the interface 709 between the two immiscible solutions. In the example of FIGS. 8A and 8B, the system includes a vessel 803 containing the two immiscible solutions. As shown in FIG. 7, a first immiscible solution layer including the aqueous solution 703 with precoated nanoparticles is in contact with a second immiscible solution layer including the organic solution 706 along the interface 709. The composite formed at the interface 709 may be extracted using an extraction assembly such as illustrated in FIGS. 8A and 8B.

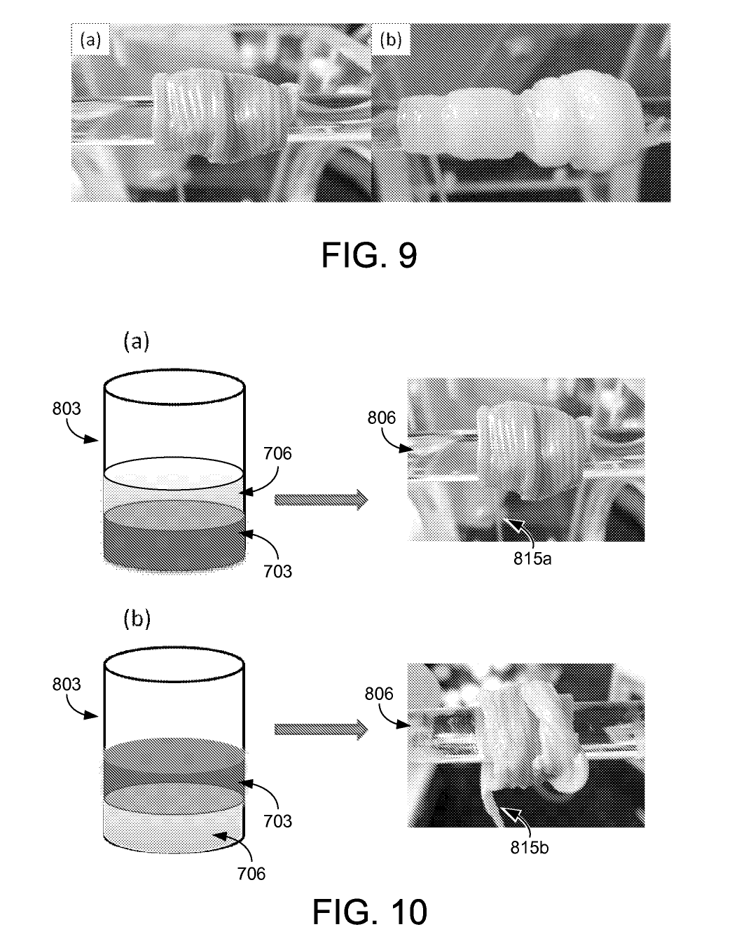

In the example of FIGS. 8A and 8B, the extraction assembly includes a spool 806 coupled to a drive system 809 (e.g., a variable speed drive system). FIG. 8A shows the drive system 809 rotating the spool 806 through a drive belt 812. The composite fibers 815 are drawn up onto the rotating spool 806. The speed of the rotating spool 806 may be varied to, e.g., avoid breakage (or discontinuity) of the composite fiber 815 or control size of the composite fiber 815. The collected composite fiber 185 may then be removed from the spool 806. In some implementations, the removed composite fiber 815 may be hot pressed or formed into a desired shape for use. It may also be possible to remove the composite material from the interface as, e.g., a sheet or other form. Referring to FIG. 9, a clear distinction can be seen between the precoated SWNT/nylon composite pictured in FIG. 9(a) and neat nylon 6,10 shown in FIG. 9(b), which was collected using the same setup as FIGS. 8A and 8B, based on the different color. The distinction is evident even when using a dilute precoated SWNTs suspension of about 20 mg/L.

One of the major roles of surfactants is to reduce the surface tension of solutions; however, the reduction in surface tension can be problematic to the spinning of the composite fiber and may result in discontinuous fibers. In the embodiment of FIG. 10(a), the precoated SWNT suspension 703 is below the organic solution 706, which helps to strip surfactant from the fiber 815a as it forms. A low density solvent (ρ<1 g/cm³) such as hexane may be chosen as the organic solution 706 for the bulk polymerization reaction rather than carbon tetrachloride because of the lower density than the precoated SWNTs suspension and high solubility of SC. This system is able to stabilize the surface of the as-spun precoated SWNTs/nylon-6,10 composite fibers. FIG. 10(b) shows an example of a composite fiber 815b formed with a high density solvent (ρ>1 g/cm³) used as the organic solution 706 sitting below the precoated SWNT suspension 703.

When synthesizing nylon-6,10 by in-situ interfacial polymerization, the byproduct (i.e., hydrochloric acid) of the condensation reaction can destabilize the SWNT suspension. However, sodium hydroxide (e.g., at less than 1 M) is typically added to neutralize the pH of the solution preventing aggregation of the suspension.

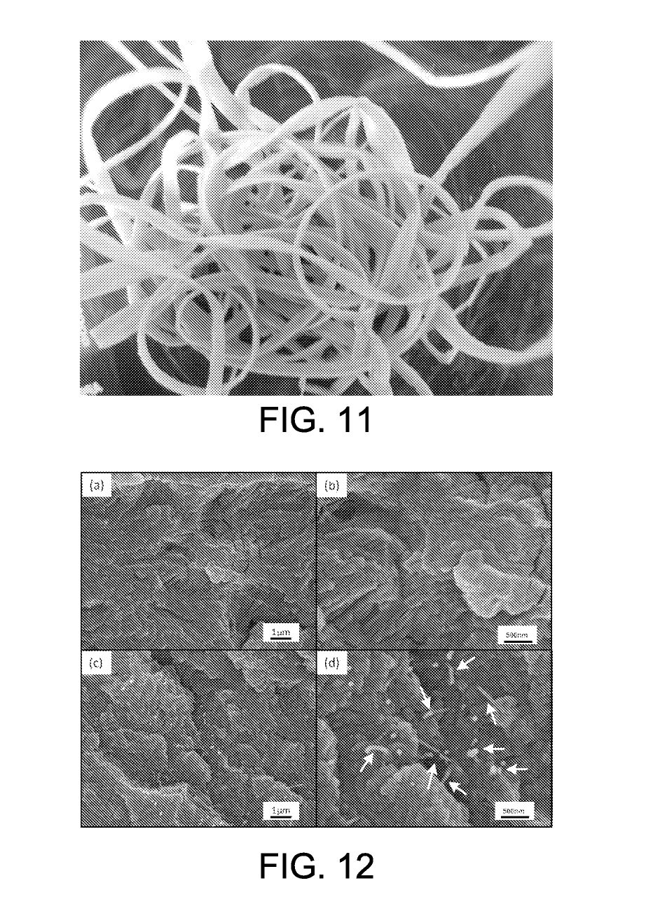

Referring to FIG. 11, shown is a picture of nylon-6,10 composite fibers spun from the interface of two immiscible solutions: a hexane layer including SC and an aqueous layer including SWNTs and HDMA. The dimension of the spun fiber was about 1.5 mm in diameter and about 4 meters in length. The spun nylon-6,10 composite fibers of FIG. 11 have a uniform color and no evidence of aggregates. FIG. 12 illustrates the dispersion of the SWNTs in the composite fiber. Scanning electron microscope (SEM) images of a fractured pure nylon-6,10 fiber are shown in FIGS. 12(a) and 12(b). SEM images of the fractured composite fiber are shown in FIGS. 12(c) and 12(d). These images 12(c) and 12(d) show that the nanotubes are dispersed throughout the composite matrix without bundling. Several individual SWNTs can be seen protruding from the fractured edge of the composite fiber (indicated by arrows) in image 12(d).

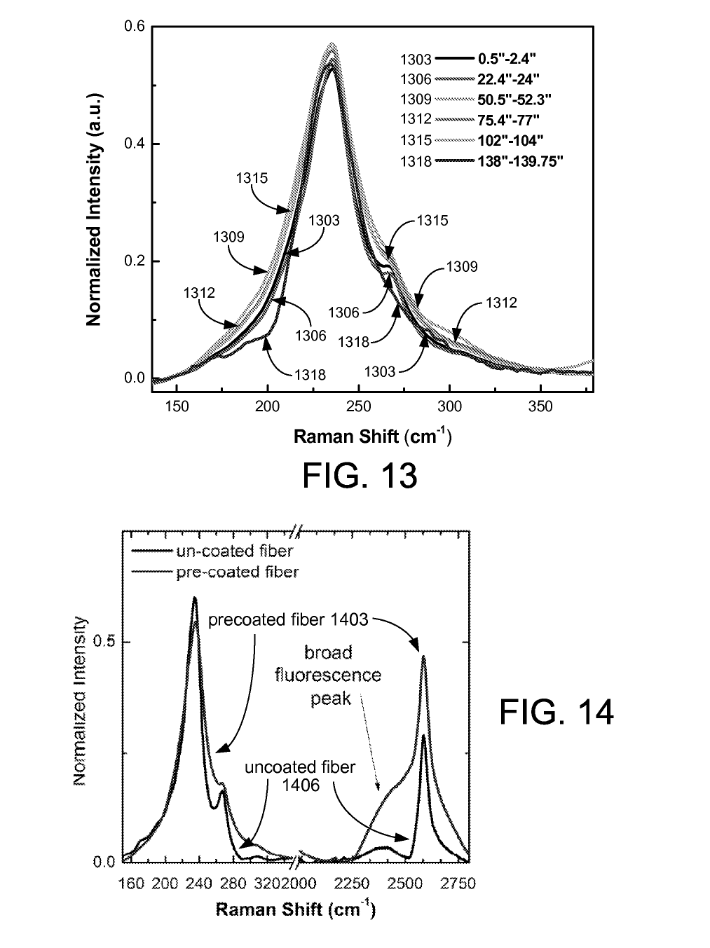

The composite fiber was also cut into segments to characterize the dispersion within the composite fiber with Raman spectroscopy. The aggregation peak at about 270 cm⁻¹ in the RBM region of the Raman spectra was used to characterize the aggregation in the fiber, as shown in FIG. 13. The evaluated segments include sections between 0.5-2.4″ (curve 1303), 22.4-24″ (curve 1306), 50.5-52.3″ (curve 1309), 75.4-77″ (curve 1312), 102-104″ (curve 1315), and 138-139.75″ (curve 1318). The ratio of the aggregation peak to the nanotube peak at about 240 cm⁻¹ is low and steadily decreases along the length of the spun fiber, indicating that the fiber starts with low aggregation and steadily improves along the length of the fiber. The uniformity of the precoated SWNTs in the nylon-6,10 matrix is maintained for at least 12 feet of the fiber.

The lack of aggregation of the precoated SWNTs is in contrast to the Raman spectra observed for uncoated SWNTs (i.e., SWNTs suspended in surfactant only), which show a distinct aggregation peak at about 267 cm⁻¹, as depicted in FIG. 14. The precoated SWNTs in the composite also appear to have a peak shift associated with them. This shift to higher frequencies indicates that the polymer tends to coat each of the nanotubes in the precoated fiber, which changes the resonant frequency (i.e., the peak frequency). Finally, fluorescence can only be observed from non-aggregated SWNTs. As seen at the higher frequencies (about 2500 cm⁻¹) in FIG. 14, the precoated SWNTs (curve 1403) still exhibit a broad fluorescence band whereas the uncoated SWNTs (curve 1406) have a significant decrease in fluorescence intensity.

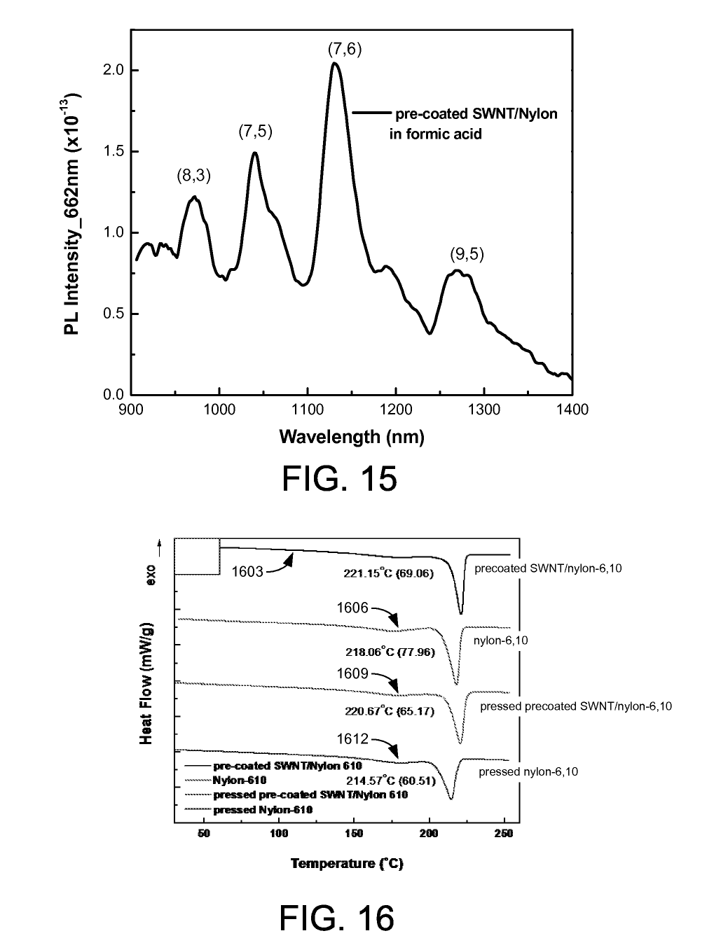

It is difficult to access the loading of SWNTs in the polymer composite but, if it is assumed that all of the SWNTs in the aqueous dispersion are integrated into the composite matrices, then a loading of about 0.02 wt % SWNTs may be achieved. The high dispersion of SWNTs throughout the precoated SWNT composite fiber can also be confirmed by the fluorescence spectra of SWNTs after dissolving the polymer with formic acid. Referring to FIG. 15, shown is the NIR fluorescence emission spectra (Ex.=662 nm) of SWNTs after dissolving the nylon from the precoated SWNTs/nylon composite. As indicated in FIG. 15, distinct fluorescence characteristics of SWNTs can still be observed, indicating the presence of individually-suspended SWNTs. This provides further indication that SWNTs remain dispersed throughout the matrix during processing since no additional energy is supplied to aid dispersion.

Neat nylon-6,10, precoated SWNT/nylon-6,10 composite, hot pressed nylon-6,10, and hot pressed SWNT/nylon-6,10 composite were taken as samples and tested for their thermal and mechanical properties. The samples were subjected to three cycles of heating and cooling between room temperature and about 260° C. with a ramp rate of about 10° C./min and cooling rate of about 20° C./min in nitrogen (N₂). Hot pressed sheets of nylon-6,10 and SWNT/nylon-6,10 composite were formed by hot pressing fibers. Differential scanning calorimetry (DSC) and thermogravimetric analysis (TGA) were used to characterize the melting temperature (Tₘ), glass transition temperature (T_{g}), and decomposition temperature. DSC as well as X-ray diffraction (XRD) are widely used to determine the crystallinity of polymers.

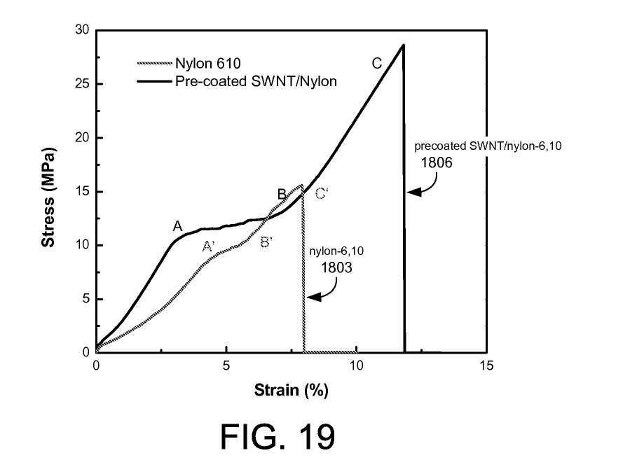

Referring to FIG. 16, shown is mass-normalized DSC data for the four sample types: precoated SWNT/nylon-6,10 (1603); nylon-6,10 (1606); pressed precoated SWNT/nylon-6,10 (1609); and pressed nylon-6,10 (1612). The endothermic peaks show the melting temperature (Tₘ) of the samples. The temperatures in FIG. 16 indicate the melting temperature or enthalpy of fusion (ΔH_{f}), which was determined from the area under the endotherm. The precoated SWNT/nylon-6,10 (1603) has about a 3° C. higher melting temperature than the neat nylon-6,10 (1606) in the heating scans of FIG. 16. However, the SWNT/nylon-6,10 composite (1603/1609) shows about 5-10% lower crystallinity in comparison to the neat nylon-6,10 for either the raw fiber (1606) or hot-pressed fiber (1612) in the first heating scan (FIG. 19A). This reduction in crystallinity may be associated with introducing SWNTs into the matrix since the alignment or orientation of SWNTs may influence the crystalline structure of the pure nylon during interfacial polymerization. The pressed nylon-6,10 (1612) had a more significant decrease in crystallinity in the cycles than the hot-pressed precoated SWNT/nylon-6,10 composite (1609). This indicates that the composite has higher thermal stability.

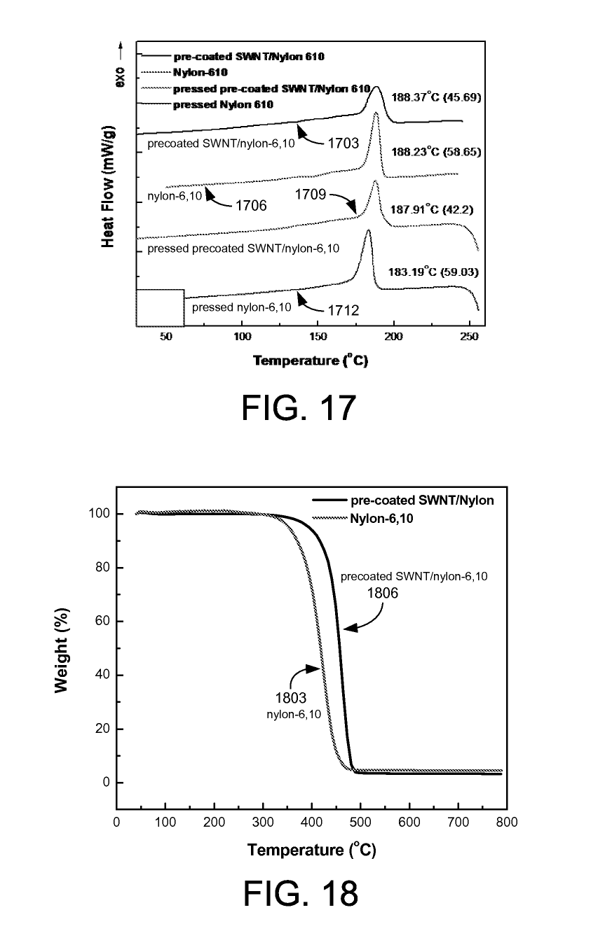

Referring now to FIG. 17, shown is DSC data for cooling scans of the samples precoated SWNT/nylon-6,10 (1703); nylon-6,10 (1706); pressed precoated SWNT/nylon-6,10 (1709); and pressed nylon-6,10 (1712), which illustrate the recrystallization temperatures and the heat of fusion of the exothermic peaks. The temperatures in FIG. 17 indicate the recrystallization temperature (enthalpy of recrystallization). The cooling curves of FIG. 17 also show similar thermal behavior to the heating curves of FIG. 16. In order to get the glass transition temperatures of the in situ polymerized nylon-6,10 and precoated SWNT/nylon-6,10 composite, a slower ramping rate (about 5° C./min) and lower onset temperature (about 0° C.) may be used on the samples. The observed glass transition temperature, T_{g}, from the DSC curve (not shown) was calculated to be about 45° C. and about 58° C. for nylon-6,10 and the precoated SWNT/nylon-6,10 composite, respectively.

The thermal stability of the samples was also confirmed by TGA in a nitrogen atmosphere with 10° C./min heating rate. FIG. 18 shows TGA curves of neat nylon-6,10 (1803) and precoated SWNT/nylon-6,10 (1806) with the data normalized to their initial weight. The thermogram displays that the degradation temperature at a 5% weight loss (T_{d5%}) is 355° C. and 394° C. for nylon-6,10 and precoated SWNT/nylon-6,10 composite, respectively. The higher decomposition temperature of the composite confirmed the higher thermal stability with the incorporation of precoated SWNTs. The incorporation of high thermal conducting materials (e.g., nanotubes) can enhance the thermal conductivity of composites and increase the thermal stability.

Fibers of precoated SWNT/nylon-6,10 composite and neat nylon-6,10 were transformed to film samples by compression molding using a hot press at 230° C. for mechanical testing. The sheet-like specimens were made with thicknesses of 0.02 inches and cut into strips. Six specimens of each sample (precoated SWNT/nylon-6,10 composite and neat nylon-6,10) were prepared to get an average of the tensile properties using a Instron test machine at room temperature. FIG. 19 shows sample stress-strain curves for neat nylon-6,10 (1903) and precoated SWNT/nylon-6,10 composite (1906) obtained with about a 2 mm/min crosshead speed. As strain is applied, the materials exhibit an elastic region up to A and A′ (yield point) with the composite having a larger slope. Beyond these points (A and A′), permanent deformation occurs with a constant load until passing their natural stretch ratio (B and B′) indicating the onset of strain hardening. The curves then show a typical polymer characteristic with the presence of strain hardening between B-C and B′-C′, where C and C′ are the rupture point. In this case, the permanent deformation of the precoated SWNT/nylon-6,10 composite (1906) is larger than the neat nylon-6,10, (1903) which denotes more flexibility of the hot pressed composite.

Without being bound by theory, two factors may explain the improvement of mechanical properties with the incorporation of CNTs or other nanoparticles: (i) good dispersion of CNTs such as SWNTs in the polymer matrix and (ii) strong van der Waals interactions between the CNTs and polymer chains. The use of precoated nanoparticles (e.g., SWNTs) in the preparation of composites can benefit both of these processes. First, the precoating provides a barrier to the aggregation of the nanoparticles in the polymer matrix. Second, the polymer chains may cross-link with unreacted ends of the polymer chains on the polymer sheath around the nanoparticles, enhancing the interaction between, e.g., the precoated SWNTs and nylon.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method of preparing a polymer nanocomposite, comprising:
providing a first immiscible solution comprising an aqueous solution including polymer-coated nanoparticles, and a first monomer;
providing a second immiscible solution comprising an organic solution including a second monomer, the first and second immiscible solutions in contact along an interface; and
extracting the polymer nanocomposite from the interface, the polymer nanocomposite comprising the polymer-coated nanoparticles dispersed within the polymer matrix.

2. The method of claim 1, wherein the polymer nanocomposite is extracted through the first immiscible solution.

3. The method of claim 1, wherein the polymer nanocomposite is extracted through the second immiscible solution.

4. The method of claim 1, wherein the nanoparticles are carbon nanotubes (CNTs).

5. The method of claim 4, wherein the CNTs are single-walled carbon nanotubes.

6. The method of claim 4, wherein the CNTs are multi-walled carbon nanotubes.

7. The method of claim 1, wherein the polymer is nylon-6,10.

8. The method of claim 1, wherein the first monomer is hexamethylene diamine (HMDA).

9. The method of claim 1, wherein the second monomer is sebacoyl chloride (SC).

10. The method of claim 1, further comprising:
precoating the nanoparticles with the polymer; and
preparing the first immiscible solution including the polymer-coated nanoparticles.

11. The method of claim 1, wherein the polymer nanocomposite is extracted as a fiber.

12. The method of claim 11, further comprising hot pressing the polymer nanocomposite fiber to form a polymer nanocomposite sheet.

13. A system, comprising:
a vessel comprising:
a first immiscible solution layer comprising an aqueous solution including polymer-coated nanoparticles, and a first monomer; and
a second immiscible solution comprising an organic solution including a second monomer, the first and second immiscible solutions in contact along an interface; and
an extraction assembly configured to extract a polymer nanocomposite from the interface, the polymer nanocomposite comprising the polymer-coated nanoparticles dispersed within the polymer matrix.

14. The system of claim 13, wherein the extraction assembly comprises a spool configured to rotate to extract the polymer nanocomposite from the interface.

15. The system of claim 14, wherein the extraction assembly further comprises a variable speed drive system coupled to the spool.

16. The system of claim 13, wherein polymer nanocomposite is extracted through the second immiscible solution layer.

17. The system of claim 13, wherein the first immiscible solution layer includes a surfactant.

18. The system of claim 13, wherein the polymer nanocomposite is hot pressed to form a sheet.
